(19) United States
(12) Patent Application Publication
(10) Pub. No.: US 2025/0170709 A1
(43) Pub. Date: May 29, 2025

(54) ROBOT CONTROL DEVICE AND MACHINING SYSTEM

(71) Applicant: FANUC CORPORATION, Minamitsuru-gun, Yamanashi (JP)

(72) Inventors: Wanfeng FU, Yamanashi (JP); Takashi SATOU, Yamanashi (JP); Yihua GU, Yamanashi (JP)

(21) Appl. No.: 18/842,671

(22) PCT Filed: May 13, 2022
(86) PCT No.: PCT/JP2022/020211

§ 371 Date: Aug. 29, 2024

(51) Int. Cl. B25J 9/16; B25J 11/00

(52) U.S. Cl. CPC B25J 9/163; B25J 11/005

(57) ABSTRACT

This robot control device is capable of easily giving instructions on an operating procedure for causing a robot to feed a workpiece to a fixation mechanism, and performs control on the robot that feeds and extracts a workpiece to and from the fixation mechanism of a machine tool. The robot control device comprises: a communication unit which transmits and receives a signal for ordering or checking the operating condition of said fixation mechanism; a memory unit which stores therein the specification of the signal transmitted or received by the communication unit; and an instruction unit which sets the signal transmitted or received by the communication unit.

### TECHNICAL FIELD

The present invention relates to a robot control device and a machining system.

### BACKGROUND ART

Conventionally, a robot has been used to supply a workpiece to industrial equipment such as a machine tool. In that case, the robot grips the workpiece and supplies the gripped workpiece to a fastening mechanism of a spindle of the machine tool. As the fastening mechanism for fastening the workpiece, for example, a chuck having about two to four claws, a mechanism for attracting the workpiece by means of air, or the like is used (for example, see Patent Document 1). Such a system requires teaching for setting an operation procedure to be performed by the robot and the fastening mechanism, that is, teaching for setting a work program that sequentially specifies a posture and a motion speed of the robot, a motion of a hand for gripping the workpiece, a motion of the fastening mechanism, and the like.

### CITATION LIST

### Patent Document

Patent Document 1: Japanese Unexamined Patent Application, Publication No. 2020-59069

### DISCLOSURE OF THE INVENTION

### Problems to be Solved by the Invention

In order for a machine tool to achieve sufficient machining accuracy, it is necessary to supply a workpiece so that the center of the workpiece coincides in position with the center of the space defined by the claws and a direction of the workpiece is parallel to a direction of the claws. Causing a robot to realize this operation requires teaching for reconciling the center position and orientation of the workpiece with the fastening mechanism. Accurate teaching, which requires a skilled person to spend a lot of time and effort, is very difficult for a worker who is not familiar with robots.

Therefore, there is a demand for a technique that facilitates teaching an operation procedure for a robot to supply a workpiece to a fastening mechanism.

### Means for Solving the Problems

An aspect of the present disclosure is directed to a robot control device for controlling a robot that supplies and picks up a workpiece to and from a fastening mechanism of a machine tool. The robot control device includes: a communication unit configured to transmit and receive a signal instructing or confirming an operation state of the fastening mechanism; a storage unit configured to store specifications of the signal that the communication unit transmits and receives; and a teaching unit configured to set the signal that the communication unit transmits and receives.

### Effects of the Invention

The present invention can facilitate teaching an operation procedure for a robot to supply a workpiece to a fastening mechanism.

### BRIEF DESCRIPTION OF THE DRAWINGS

FIG. 1 is a block diagram illustrating a configuration of a machining system according to an embodiment of the present disclosure;

FIG. 2 is a diagram illustrating a setting screen for setting an operation procedure in the machining system of FIG. 2;

FIG. 3 is a diagram illustrating a setting screen for setting an operation procedure for supplying a workpiece in the machining system of FIG. 2;

FIG. 4A is a diagram illustrating an operation according to an embodiment that is performed when a workpiece is fastened to a fastening mechanism;

FIG. 4B is a diagram illustrating an operation according to an embodiment that is performed when the workpiece is fastened to the fastening mechanism;

FIG. 5A is a diagram illustrating an operation for correcting a posture error of a workpiece;

FIG. 5B is a diagram illustrating the operation for correcting the posture error of the workpiece;

FIG. 5C is a diagram illustrating the operation for correcting the posture error of the workpiece;

FIG. 6A is a diagram illustrating an operation for correcting a position error of a workpiece; and

FIG. 6B is a diagram illustrating the operation for correcting the position error of the workpiece.

### PREFERRED MODE FOR CARRYING OUT THE INVENTION

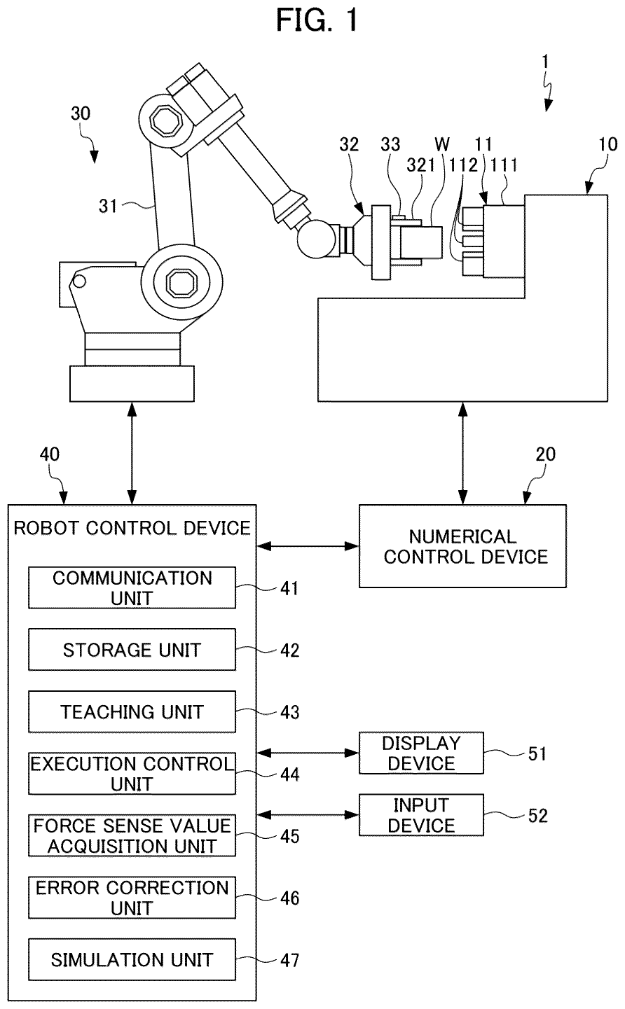

Embodiments of the present disclosure will be described below with reference to the drawings. FIG. 1 is a block diagram illustrating a configuration of a machining system 1 according to an embodiment of the present disclosure. The machining system 1 of the present embodiment includes a machine tool 10, a numerical control device 20, a robot 30, and a robot control device 40. In the machining system 1, the robot 30 supplies and picks up a workpiece W to and from the machine tool 10.

The machine tool 10 includes a fastening mechanism 11 that holds the workpiece W. The fastening mechanism 11 of the present embodiment is a chuck including a base member 111 that rotates together with a spindle, and three gripping claws 112 that are arranged on an end surface of the base member 111 at equal intervals in a circumferential direction and grip the workpiece W by moving (opening and closing) in the radial direction. The fastening mechanism is not limited to the illustrated configuration, and may have, for example, four or more gripping claws, or may be configured to attract and hold the workpiece W by vacuum force or magnetic force.

The numerical control device 20 is a well-known control device for controlling the machine tool 10. The numerical control device 20 outputs a signal indicating a state of the fastening mechanism 11 to the robot control device 40, receives a signal instructing opening/closing the fastening mechanism 11 from the robot control device 40, and causes the fastening mechanism 11 to operate in accordance with the received signal.

The robot 30 is controlled by the robot control device 40 and supplies and picks up the workpiece W. Typically, a vertical articulated robot may be used as the robot 30. However, a robot of a different type may be used. The robot 30 according to the present embodiment includes an arm 31 with a plurality of joints, a gripping mechanism 32 that is provided at a leading end of the arm 31 and grips the workpiece W, and a force sense value detector 33 that detects a force sense value reflecting a force acting on the gripping mechanism 32 due to interaction with the workpiece W.

The gripping mechanism 32 has a plurality of gripping fingers 321 for gripping the workpiece W. The force sense value detector 33 may be a sensor that detects, for example, a force, a bending moment, a strain, or the like that acts on the gripping fingers 321 or a body of the gripping mechanism 32, and may be configured to detect a current value, a torque, or the like of a motor for a drive shaft of the arm 31. That is, the force sense value detector 33 may be a part of the arm 31. Furthermore, as the force sense value detector 33, a three-axis or six-axis force sensor of a strain gauge type, a capacitance type, a magnetic type, an optical type, or the like may be used.

The robot control device 40 is per se one embodiment of the robot control device according to the present disclosure. The robot control device 40 of the present embodiment includes a communication unit 41, a storage unit 42, a teaching unit 43, an execution control unit 44, a force sense value acquisition unit 45, an error correction unit 46, and a simulation unit 47. The robot control device 40 may be implemented by one or more computer devices that include, for example, a memory, a processor, an input/output interface, and the like, and that execute appropriate control programs. The constituent elements of the robot control device 40 refer to categorized functions of the robot control device 40, and do not have to be clearly distinguishable from each other in terms of physical configuration and program configuration. A display device 51 such as a display panel and an input device 52 such as a keyboard and a mouse are connected to the robot control device 40, whereby a user interface is implemented. The display device 51 and the input device 52 may be provided integrally with the robot control device 40. Alternatively, the display device 51 and the input device 52 may be integrated into a touch panel or the like, for example.

The communication unit 41 transmits and receives a signal for instructing or confirming an operation state of the fastening mechanism 11. Specifically, the communication unit 41 receives, from the numerical control device 20, a signal that is ON in one of a state in which the gripping claws 112 of the fastening mechanism 11 are closed and a state in which the gripping claws 112 are open, and that is OFF in the other state. Furthermore, the communication unit 41 transmits a signal for requesting the numerical control device 20 to close or open the gripping claws 112 of the fastening mechanism 11. The specifications of these signals, i.e., the modes of the signals and the addresses of the input/output interfaces used for transmitting and receiving the signals, etc., may vary depending on the type of the fastening mechanism 11. For example, when the gripping claws 112 are closed, an ON signal is outputted in the case of a fastening mechanism 11 of a certain type, whereas an OFF signal is outputted in the case of a fastening mechanism 11 of a different type. The signal that the communication unit 41 transmits and receives is not limited to the ON/OFF signal, and may be an analog signal or a signal that conveys information by means of changes over time between ON and OFF.

The storage unit 42 stores the specifications of a signal that is transmitted and received, for each type of the fastening mechanism 11. The type of the fastening mechanism 11 can be identified in accordance with the model into which the fastening mechanism 11 is categorized, but may be identified in accordance with a code or the like that a user uses to identify the fastening mechanism 11, or may be identified in accordance with a group that is set based on the specifications of signals. That is, a plurality of fastening mechanisms 11 may be regarded as individuals of different types, or a group of a plurality of fastening mechanisms 11 of different models may be regarded as one type.

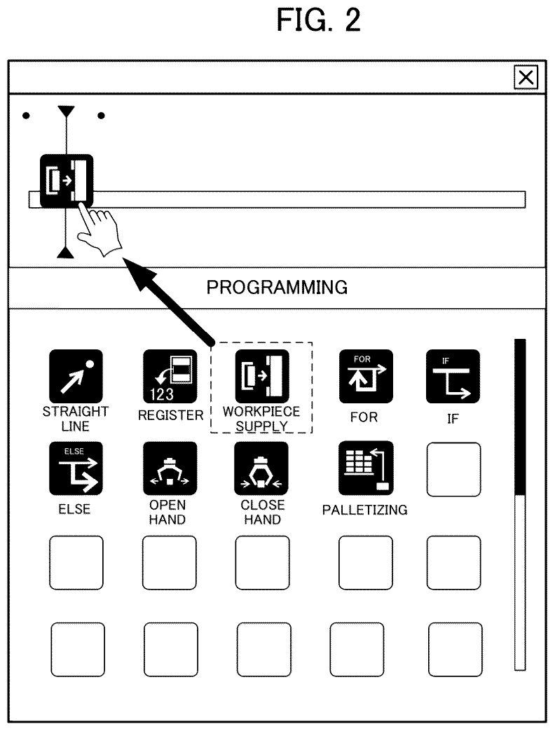

The teaching unit 43 may be configured to provide a user interface illustrated in FIG. 2 as an example. Specifically, the display device 51 displays a space (execution line) set therein together with icons each representing an operation procedure of a unit operation, such as an operation for supplying a workpiece W and an operation for picking up a workpiece W. The user arranges the icons in the space (on the execution line) in the order in which the unit operations represented by the icons are to be performed, whereby parameters that specify an operation procedure for the robot 30 to carry out the unit operations represented by the icons are automatically set. In other words, the teaching unit 43 may be configured to provide a user interface that facilitates teaching of operations for the robot 30. Examples of the parameters specifying the operation procedure include the coordinates of a reference point of the robot 30, a position and a speed of each drive shaft (particularly, a speed at which the robot approaches the fastening mechanism 11), a state of the gripping fingers 321, and the like. Furthermore, the teaching unit 43 may be configured to switch, in response to the user arranging or selecting an icon representing a unit operation, the screen displayed on the display device 51 to a setting screen that allows the user to input minimum information necessary for setting the operation procedure of the unit operation, as needed.

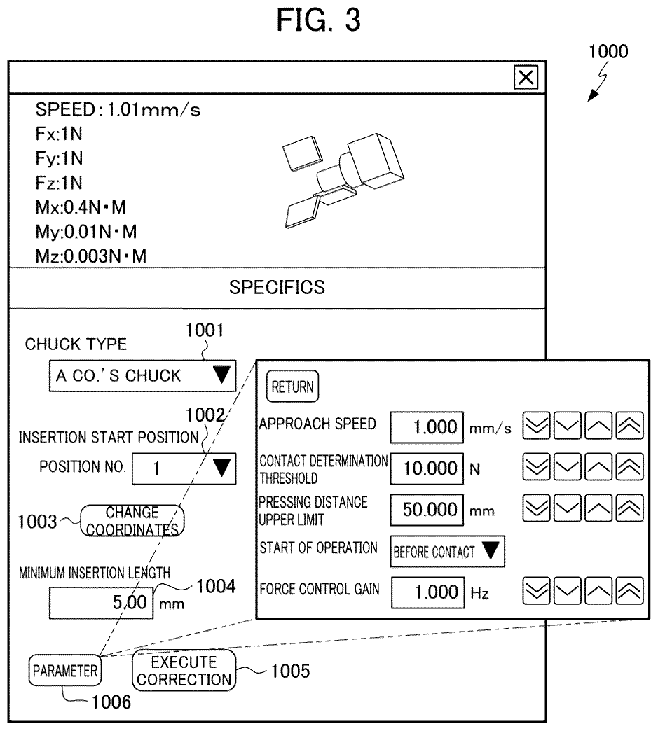

When setting the operation procedure for supplying or picking up the workpiece W, the teaching unit 43 refers to the storage unit 42, and sets signals to be transmitted and received by the communication unit 41 in accordance with the type of the fastening mechanism 11. The teaching unit 43 receives an input by the user, and sets the operation procedure for the fastening mechanism 11 and the robot 30 to supply or pick up the workpiece W, based on the received input. For this end, the teaching unit 43 displays a setting screen for prompting the user to input a minimum necessary information when an icon representing supply or picking up of the workpiece W is arranged on the execution line. FIG. 3 illustrates a setting screen 1000 that the teaching unit 43 displays on the display device 51 for the purpose of setting an operation for supplying the workpiece W. The teaching unit 43 is configured to allow for setting the operation procedure of the operation for supplying the workpiece W via the single setting screen 1000.

The operation for supplying the workpiece W includes a step of causing the numerical control device 20 to open the gripping claws 112 of the fastening mechanism 11, a step of positioning the distal end of the robot 30 at a supply start position that is set such that the workpiece is placed on the rotation axis of the spindle of the machine tool 10, a step of causing the robot 30 to move the workpiece W by a minimum insertion length or more in the axial direction of the fastening mechanism 11, thereby inserting the workpiece W into the fastening mechanism 11, and a step of causing the numerical control device 20 to close the gripping claws 112 of the fastening mechanism 11.

In the step of opening the gripping claws 112 and the step of closing the gripping claws 112, the teaching unit 43 automatically sets the mode of a signal to be transmitted and received by the communication unit 41 and the address of the input/output interface in accordance with the type of the fastening mechanism 11. The teaching unit 43 may be configured to acquire the type of the fastening mechanism 11 from the numerical control device 20, but is preferably configured to identify the type of the fastening mechanism 11 based on a received user's input, so that an existing numerical control device 20 can also be used. For this reason, a pull-down menu 1001 for allowing the user to select a fastening mechanism is displayed on the setting screen 1000 illustrated in FIG. 3.

In order to teach the step of positioning the robot 30 at the supply start position, that is, to set the operation parameters required by the execution control unit 44, the teaching unit 43 displays, on the setting screen 1000 illustrated in FIG. 3, a pull-down menu 1002 for allowing the user to select the supply start position from a plurality of preset values, specifically, to select one of numbers denoting preset coordinates. The setting screen 1000 displayed by the teaching unit 43 includes a button 1003 for displaying a pop-up window for correction of the preset value (coordinates) of the supply start position. The pop-up window displayed upon operation of the button 1003 may include a plurality of text boxes respectively displaying, in an editable manner, numerical values (X, Y, Z, W, P, R) that specify the position and orientation of a leading end reference point of the robot 30.

The teaching unit 43 displays, on the setting screen 1000, a text box 1004 that allows the user to input the minimum insertion length for the step of inserting the workpiece W into the fastening mechanism 11.

Furthermore, as illustrated in FIG. 3, the teaching unit 43 displays a test execution button 1005 and a button 1006 on the setting screen 1000. The test execution button 1005 is for starting a process in which the execution control unit 44 executes the operation procedure and in which the error correction unit 46 optimizes the operation procedure based on a force sense value. The button 1006 is for displaying a pop-up window for adjustment of parameters, such as a speed, a determination threshold, and the like, in order for the user to optimize the operation procedure based on the force sense value.

The execution control unit 44 causes the fastening mechanism 11 and the robot 30 to execute an operation procedure in accordance with the procedure taught by the teaching unit 43. Preferably, the execution control unit 44 is configured to immediately reflect the operation procedure corrected by the error correction unit 46 and to cause the fastening mechanism 11 and the robot 30 to operate accordingly.

The force sense value acquisition unit 45 acquires, from the force sense value detector 33, a force sense value that reflects a force generated due to the interaction between the workpiece W and the robot 30 when the operation procedure is executed. That is, the force sense value acquisition unit 45 acquires the magnitude and direction of the force with which the workpiece W pushes back the gripping mechanism 32 of the robot 30 in response to the workpiece W coming into contact with the fastening mechanism 11.

The error correction unit 46 corrects errors of the position and posture of the robot during the operation procedure, based on the force sense value acquired by the force sense value acquisition unit, and optimizes the operation procedure. The details of the error correction by the error correction unit 46 will be described below.

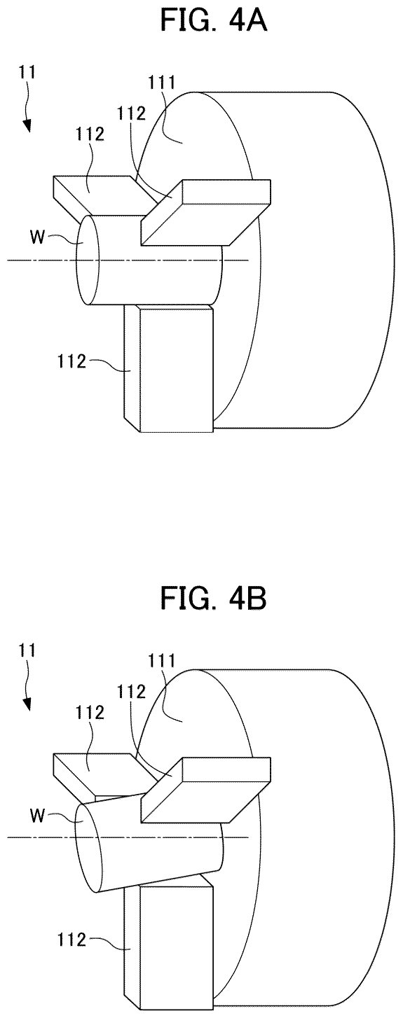

FIGS. 4A and 4B are diagrams illustrating an operation according to the present embodiment that is performed when the workpiece W is supplied and fastened to the fastening mechanism 11. When supplying the workpiece W to the fastening mechanism 11, the robot 30 operates in a direction L in which the workpiece W is supplied to the fastening mechanism 11. The robot 30 supplies the workpiece W having a circular columnar shape to the vicinity of the center position of the gripping claws 112, and the machine tool 10 closes the gripping claws 112, whereby the workpiece W is fastened at the center position of the base member 111.

In a case where the workpiece W is supplied in correct position and posture to the base member 111 of the fastening mechanism 11, the center axis of the base member 111 and the center axis of the workpiece W coincide with each other as illustrated in FIG. 4A when the gripping claws 112 are closed. In this case, the machine tool 10 can achieve good machining accuracy.

However, in a case where the workpiece W is supplied while having a large position error and a large posture error with respect to the base member 111, the workpiece W may be fastened in a state where the center axis of the base member 111 is misaligned with the center axis of the workpiece W as illustrated in FIG. 4B when the gripping claws 112 are closed. In this case, the machine tool 10 cannot achieve good machining accuracy.

Therefore, as will be described below, the error correction unit 46 performs a process (force sense value control) for correcting errors in the positions and orientations of the workpiece W and the fastening mechanism 11.

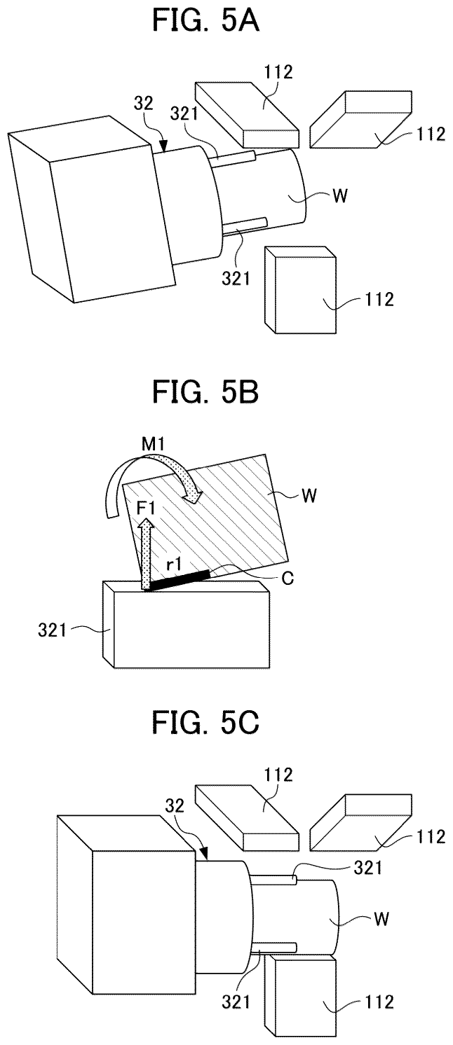

FIGS. 5A, 5B, and 5c are diagrams illustrating an operation for correcting a posture error of the workpiece W. As illustrated in FIG. 5A, the robot control device 40 controls the robot 30 to position the workpiece W to the base member 111. Here, in the example illustrated in FIG. 5A, the workpiece W has a posture error with respect to the base member 111. Thereafter, the error correction unit 46 of the robot control device 40 executes the force sense value control for correcting parameters of the operation procedure based on a force sense value.

Specifically, while executing the force sense value control, the error correction unit 46 controls and causes the robot 30 to press the workpiece W onto any one of the gripping claws 112. More specifically, while executing the force sense value control, the error correction unit 46 causes the robot 30 to press the workpiece W onto the fastening mechanism 11 in a direction substantially orthogonal to the direction in which the workpiece W is supplied to the fastening mechanism 11.

FIG. 5B is a diagram illustrating an operation for correcting the posture of the workpiece W in the case where the workpiece W is pressed onto the gripping claw 112. As illustrated in FIG. 5B, when the robot 30 presses the workpiece W onto the gripping claw 112, a moment M1 is generated around the center (rotation center C) of the contact surface between the workpiece W and the gripping claw 112. Here, a reaction force against a force with which the workpiece W is pressed onto the gripping claw 112 is defined as a force F, a distance from the rotation center C of the workpiece W to the position on which the force F acts is defined as a distance r2, the moment M1 is expressed as [M1=r2×F].

When the force sense value detector 33 detects the moment M1, the error correction unit 46 executes the force sense value control so that the moment with which the workpiece W is pressed onto the fastening mechanism 11 becomes 0.

Specifically, in response to the force sense value detector 33 detecting the moment M1, the error correction unit 46 causes the robot 30 to rotate the workpiece W around the rotation center C to correct the posture of the workpiece W. As a result, as illustrated in FIG. 5C, the workpiece W is rotated in a direction in which the moment M1 decreases, whereby the posture error of the workpiece W is corrected.

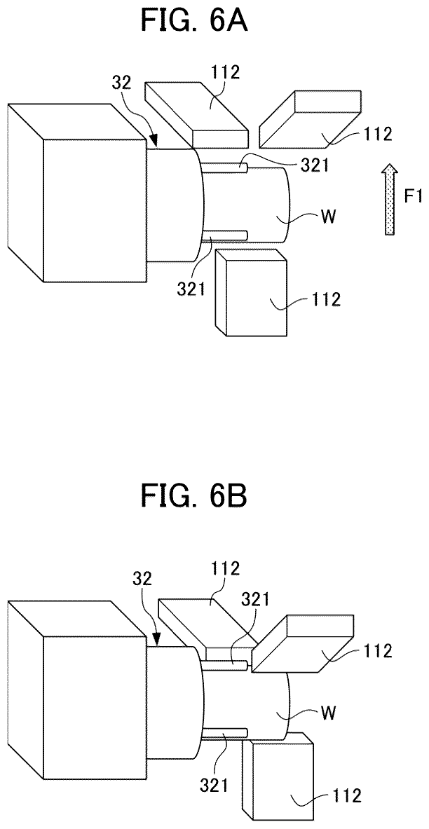

FIGS. 6A and 6B are diagrams illustrating an operation for correcting a position error of the workpiece W. As illustrated in FIG. 6A, the robot control device 40 controls the robot 30 to position the workpiece W to the end surface of the base member 111. Here, in the example illustrated in FIG. 6A, the workpiece W has a position error with respect to the base member 111. Thereafter, the error correction unit 46 executes the force sense value control.

Specifically, during the force sense value control, the error correction unit 46 transmits a control signal to the numerical control device 20 via the communication unit 41 so as to cause the machine tool 10 to perform an operation to close the gripping claws 112 of the fastening mechanism 11. That is, the numerical control device 20 operates the fastening mechanism 11 in conjunction with the force sense value control by the robot 30 and the robot control device 40.

As illustrated in FIG. 6B, when the gripping claws 112 are closed, the workpiece W receives a force F1 in a direction substantially orthogonal to the direction in which the workpiece W is supplied to the fastening mechanism 11, due to the gripping claw 112. In response to the force sense value detector 33 detecting the force F1, the error correction unit 46 moves the workpiece W in a direction in which the force F1 decreases, by the action of the force sense value control, whereby the position of the workpiece W is corrected.

As described above, in the case where the gripping claws 112 are closed during the force sense value control, if the workpiece W has a position error, the workpiece W is moved in a direction in which the position error is eliminated, by the action of the force sense value control. As the force sense value control described above, for example, impedance control, damping control, or the like is employed, but the present invention is not limited thereto.

The machine tool 10 may repeatedly operate the fastening mechanism 11 a preset number of times. The error correction unit 46 causes the fastening mechanism 11 to repeatedly opening and closing the gripping claws 112 a predetermined number of times during execution of the force sense value control. As a result, a position error and a posture error of the workpiece W are corrected every time the gripping claws 112 are opened and closed. In a case where the fastening mechanism 11 is an attracting mechanism, the machine tool 10 repeatedly attracts and releases the workpiece W a predetermined number of times during execution of the force sense value control. As a result, a position error and a posture error of the workpiece W is corrected every time the workpiece W is attracted and released.

The robot 30 or the machine tool 10 may include a movement amount detector that detects a movement amount of the workpiece W, and the error correction unit 46 may repeat the force sense value control until the movement amount of the workpiece W becomes equal to or less than a predetermined distance or a predetermined angle when the fastening mechanism 11 is in operation.

Furthermore, in a case where an excessive force or moment is generated while the fastening mechanism 11 is in operation, the machine tool 10 may cause the fastening mechanism 11 to release the workpiece W, and then operate the fastening mechanism 11 again to fasten the workpiece W by the fastening mechanism 11. Specifically, in a case where a value equal to or greater than a predetermined value indicating an excessive force or moment is detected by the force sense value detector 33 while the fastening mechanism 11 is in operation, the machine tool 10 may interrupt the operation of the fastening mechanism 11, cause the fastening mechanism 11 to release the workpiece W, and thereafter, operate the fastening mechanism 11 again to fasten the workpiece W by the fastening mechanism 11.

Although the method in which the operation for closing the fastening mechanism 11 is performed after the workpiece W is pressed onto the fastening mechanism 11 has been described, the operation for pressing the workpiece W may be performed after the fastening mechanism 11 is closed.

The simulation unit 47 performs a simulation of an operation procedure and displays a result of the simulation. The simulation unit 47 preferably displays a calculational force sense value together with the simulation result, and may be configured to display, in addition to the force sense value, parameters such as a speed and a contact threshold during the simulation, together with the simulation result, for example. The simulation unit 47 preferably displays the simulation result as a part of the setting screen 1000. That is, it is preferable to ensure a space that can be used for displaying the result of the simulation by the teaching unit 43. In a case where a problem occurs during the simulation, the simulation unit 47 may display an abnormal value among the displayed parameters in an identifiable manner, for example, by highlighting. This feature makes it possible for the user to easily grasp a parameter that may cause a problem.

It should be noted that the present invention is not limited to the embodiments described above. The effects described in the above embodiments are merely favorable ones of the effects exerted by the present invention. The effects of the present invention are not limited to those described above.

For example, the robot control device according to the present invention may be capable of setting an operation procedure related to picking up of the workpiece.

### EXPLANATION OF REFERENCE NUMERALS

1: Machining system
10: Machine tool
11: Fastening mechanism
111: Base member
112: Gripping claw
20: Numerical control device
30: Robot
31: Arm
32: Gripping mechanism
321: Gripping finger
33: Force sense value detector
40: Robot control device
41: Communication unit
42: Storage unit
43: Teaching unit
44: Execution control unit
45: Force sense value acquisition unit
46: Error correction unit
47: Simulation unit
W: Workpiece

1. A robot control device for controlling a robot that supplies and picks up a workpiece to and from a fastening mechanism of a machine tool, the robot control device comprising:
a communication unit configured to transmit and receive a signal instructing or confirming an operation state of the fastening mechanism;
a storage unit configured to store specifications of the signal that the communication unit transmits and receives; and
a teaching unit configured to set the signal that the communication unit transmits and receives.

2. The robot control device according to claim 1, wherein
the teaching unit receives an input by a user, and sets an operation procedure for the fastening mechanism and the robot to supply or picking up the workpiece, based on the input received.

3. The robot control device according to claim 2, comprising:
an execution control unit configured to cause the fastening mechanism and the robot to execute the operation procedure;
a force sense value acquisition unit configured to acquire a force sense value that reflects a force generated by interaction between the workpiece and the robot when the operation procedure is executed; and,
an error correction unit configured to correct an error of a position and a posture of the robot during the operation procedure, based on the force sense value acquired by the force sense value acquisition unit.

4. The robot control device according to claim 3, wherein
the teaching unit identifies a type of the fastening mechanism in accordance with the input received.

5. The robot control device according to claim 4, wherein
the execution control unit sets a parameter based on the type of the fastening mechanism.

6. The robot control device according to claim 2, further comprising:
a simulation unit configured to perform a simulation of the operation procedure and display a result of the simulation.

7. The robot control device according to claim 2, wherein
the teaching unit is configured to allow for setting the operation procedure via a single setting screen.

8. The robot control device according to claim 7, wherein
the teaching unit is configured to set an operation parameter of the robot to a preset value, and
the setting screen includes a button for displaying a pop-up window for correction of the preset value.

9. A machining system comprising:
the robot control device according to claim 1;
a machine tool including the fastening mechanism; and
a robot controllable by the robot control device and configured to supply and pick up a workpiece to and from the fastening mechanism.
